(19) United States
(12) Patent Application Publication
(10) Pub. No.: US 2010/0297285 A1
(43) Pub. Date: Nov. 25, 2010

(54) Pipe Body Extrusion Device

(75) Inventor: Chuan-Hsing Chen, Taichung City (TW)

Correspondence Address: Chuan-Shing Chen, P.O. BOX 46-669, Taipei, omitted

(73) Assignee: Chuan-Hsing Chen, Taichung City (TW)

(21) Appl. No.: 12/765,890

(22) Filed: Apr. 23, 2010

(30) Foreign Application Priority Data
May 25, 2009 (TW) 098209127

(51) Int. Cl. B29C 47/08

(52) U.S. Cl. 425/505

(57) ABSTRACT

A pipe body extrusion device includes a fixed unit, a holding bracket, a packing bolt, a drive unit, a pipe expanded and molded piece, a clip unit, and an operating unit; in which the holding bracket is for clipping a round pipe and putting into a holding space of the fixed unit, the packing bolt is locked into the fixed unit and then the holding bracket is clipped to be positioned, the drive unit is screwed and locked at the fixed unit including a drive rod, the pipe expanded and molded piece is installed at the drive rod and through the clip unit for rapidly integrating or disconnecting with the drive rod, and the operating unit is for driving the drive rod for leading the pipe expanded and molded piece near or away from the round pipe; thus, the present invention has the features of integral structure, simple operation, and enhancing operational efficiency.

### BACKGROUND OF THE INVENTION

(a) Field of the Invention

The present invention relates to an extrusion device, specifically to a pipe body extrusion device.

(b) Description of the Prior Art

As shown in FIG. 1, the endcap of a plastic round pipe 10 (such as brake fluid tube) needs to be extruded and molded to a flange 11 to stem the nut of the round pipe 10 fitted. In addition, the head face of the flange 11 can be convex arc-shaped or concave horn-shaped to be consistent with use requirement.

As shown in FIGS. 2, 3, and 4, a conventional pipe body extrusion device 20 includes a lock bracket 21, a holding bracket 22 installed in the lock bracket 21, a handle 23 extending from the lock bracket 21, a slider 24 slide at the lock bracket 21, and a extrusion unit 25 screwed and locked at the slider 24.

The lock bracket 21 is equipped with a fixed block 211, an active block 212 rotatably hinged on the fixed block 211, a bolt 213 fixed at the fixed block 211, and a nut 214 screwed and locked at the bolt 213 to make the active block 212 lock with the fixed block 211.

The holding bracket 22 includes two half-shaped dies 221 pairing with each other, which are respectively installed at the fixed block 211 and the active block 212, for clipping the round pipe 10 (referring to FIG. 1).

The slider 24 slide at the lock bracket 21 along the direction perpendicular to the bolt 213 includes a screw hole 241 aligning with the holding bracket 22.

The extrusion unit 25 includes a lock connector 251, a spring 252 installed in the lock connector 251, an interlocking rod 253 plugged in the spring 252, a hydraulic cylinder 254 fitted at the outside of the interlocking rod 253 and screwed and locked at the lock connector 251, an operating handle 255 screwed and locked at the hydraulic cylinder 254, and a pipe expanded and molded head portion 256 screwed and locked at the interlocking rod 253.

As shown in FIGS. 1, 2, 3, and 4, in using, the round pipe 10 is first put in one of the half-shaped dies 221, then the holder 211 is covered with the active block 212, to make two half-shaped dies 221 pair with each other, then the nut 214 is screwed and locked at the bolt 213 and tightened to clip the round pipe 10 to be positioned, then the slider 24 is slide at the lock bracket 21, and the lock connector 251 of the extrusion unit 25 is screwed and locked at the screw hole 241 of the slider 24 to make the pipe expanded and molded head portion 256 align with the endcap of the round pipe 10, and then the operating handle 255 is turned to make the interlocking rod 253 driven by the hydraulic cylinder 254 lead the pipe expanded and molded head portion 256 toward the endcap of the round pipe 10, thus the endcap of the round pipe 10 is extruded and molded to the flange 11.

Although the pipe body extrusion device 20 has the above functions of use, there are still shortcomings as following:

1. complex integral structure;

2. time-consuming and inefficient operation; and

3. because of the pipe expanded and molded head portion 256 screwed and locked at the interlocking rod 253, the pipe expanded and molded head portion 256 must be turned either assembly or disassembly, resulting in synchronous rotation between the pipe expanded and molded head portion 256 and the interlocking rod 253 due to rotatable design for the interlocking rod 253, thus the pipe expanded and molded head portion 256 cannot be tightened or loosened, affecting the operational efficiency.

### SUMMARY OF THE INVENTION

Therefore, the object of the present invention is to provide a pipe body extrusion device, which has the features of simple integral structure, time-saving operation, and enhancing operational efficiency.

Thus, the pipe body extrusion device of the present invention contains a fixed unit, a holding bracket, a packing bolt, a drive unit, a pipe expanded and molded piece, a clip unit, and an operating unit.

The fixed unit includes a holder, and a fixed handle installed at the holder, in which the holder is equipped with a screw hole column extending along the first direction, two lateral columns respectively extending from the screw hole column along the first direction, and a check block fixed between the two lateral columns along the second direction which is perpendicular to the first direction, the above screw hole column, lateral columns, and check block coordinated to form a holding space.

The holding bracket, for being put into the holding space, includes two half-shaped dies pairing with each other, in which each half-shaped die is equipped with a semicircular groove installed along the first direction, and a shallow groove with enlarged diameter installed at the junction of the head face of the half-shaped die and the semicircular groove.

The packing bolt is locked into one of the lateral columns and pushing against the holding bracket along the second direction to clip the holding bracket to be positioned.

The drive unit includes a lock bracket screwed and locked at the screw hole column along the first direction, and a drive rod extends from the lock bracket along the first direction and aligns with the drive rod of the holding bracket, in which the drive rod is equipped with a plug-receiving part placed at outside of the lock bracket, a jack installed at the plug-receiving part along the first direction, and a through hole installed at the plug-receiving part and through the jack.

The pipe expanded and molded piece includes a plug rod plugged in the jack of the drive rod, an extrusion head extending toward the direction away from the plug rod and aligning with the shallow groove of the holding bracket, and a circular groove installed at the plug rod.

The clip unit includes a first retaining ring installed at the plug-receiving part near the lock bracket, a second elastic piece fitted at the plug-receiving part and stemmed by the first retaining ring, a ball bearing and a third elastic piece installed in the through hole of the drive rod, a control ring fitted at the plug-receiving part, and a second retaining ring installed at the plug-receiving part to stem the control ring; in which the control ring includes a clip hole with small aperture and a release hole with large aperture, thus the ball bearing moves between the clip position and the release position, relative to the circular groove of the pipe expanded and molded piece.

The operating unit is for driving the drive unit for leading the pipe expanded and molded piece to move along the first direction.

With the above-mentioned composition, the endcap of the round pipe installed in the holding bracket is extruded and molded to a flange, thus the present invention has the features of integral structure, simple operation, and enhancing operational efficiency.

### BRIEF DESCRIPTION OF THE DRAWINGS

FIG. 1 is a stereogram of a plastic round pipe;

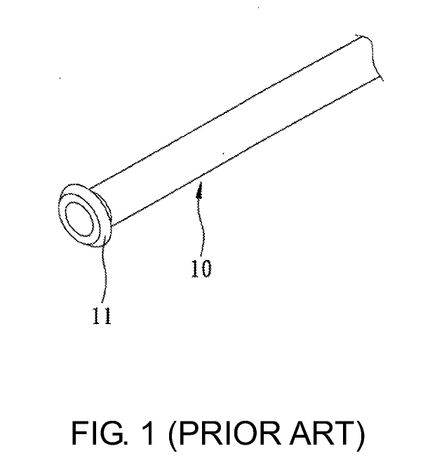

FIG. 2 is a local stereogram of a conventional pipe body extrusion device, depicting the open state of a lock bracket;

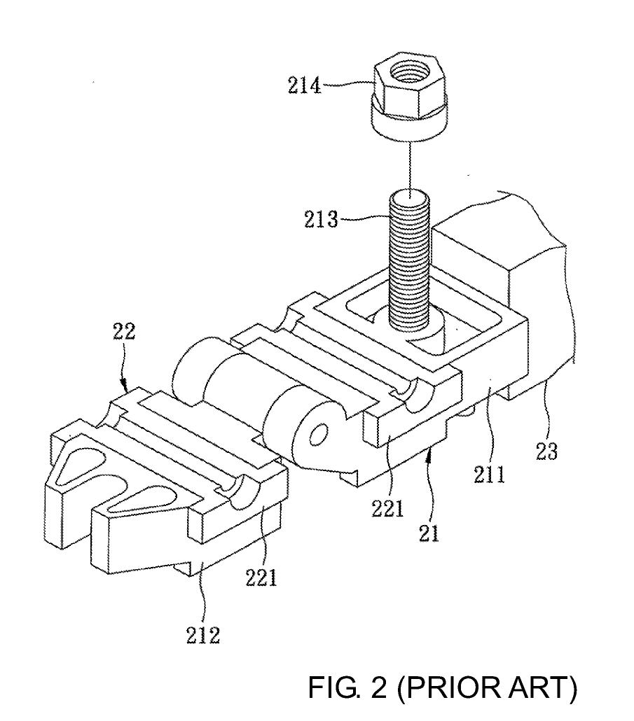

FIG. 3 is a local exploded stereogram of the conventional pipe body extrusion device;

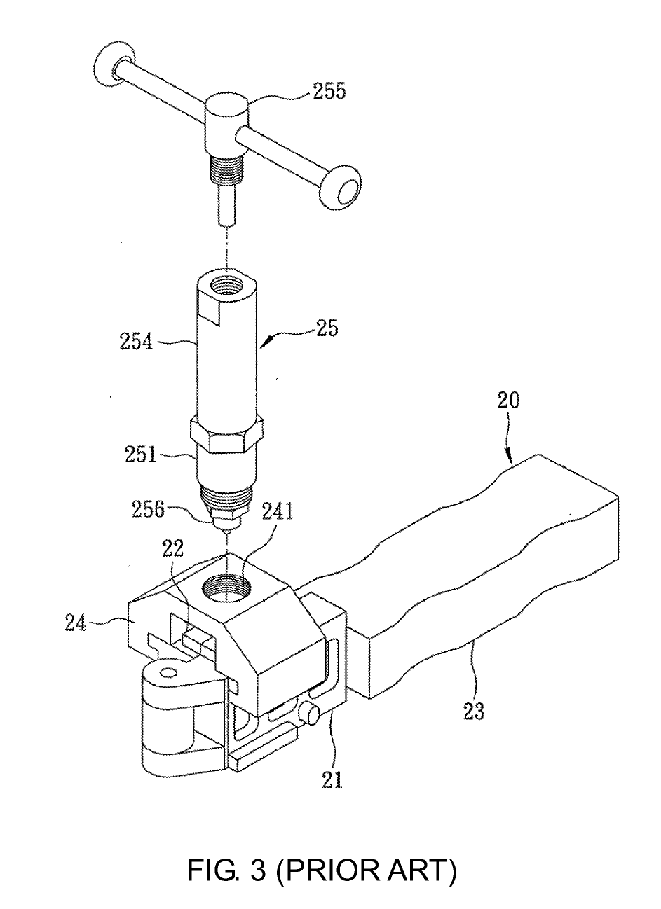

FIG. 4 is a local exploded stereogram of the conventional pipe body extrusion device, depicting an extrusion unit;

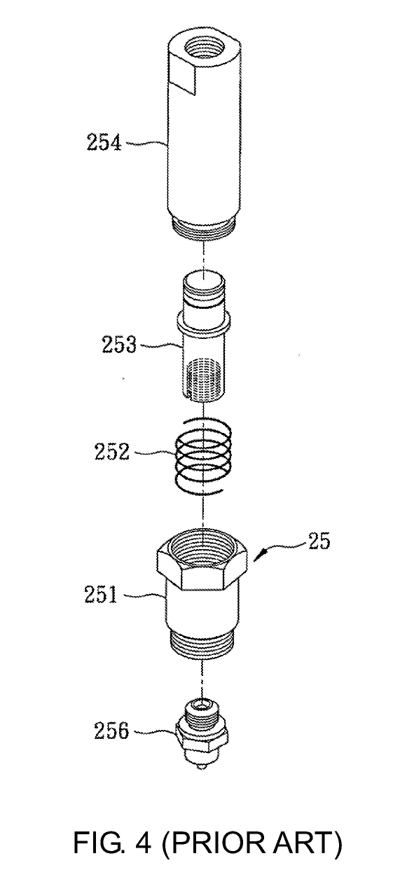

FIG. 5 is an exploded stereogram showing the first preferred embodiment of the pipe body extrusion device, according to the present invention;

FIG. 6 is a combined stereogram of the preferred embodiment;

FIG. 7 is a combined sectional view of the preferred embodiment, depicting the state before extrusion;

FIG. 8 is similar to FIG. 7, depicting the state after extrusion;

FIG. 9 is a combined stereogram showing the second preferred embodiment of the pipe body extrusion device, according to the present invention; and

FIG. 10 is a combined sectional view of the second preferred embodiment, depicting a drive unit.

### DESCRIPTION OF MAIN COMPONENT SYMBOLS

10: plastic round pipe

11: flange

20: pipe body extrusion device

21: lock bracket

211: fixed block

212: active block

213: bolt

214: nut

22: holding bracket

221: half-shaped die

23: handle

24: slider

241: screw hole

25: extrusion unit

251: lock connector

252: spring

253: interlocking rod

254: hydraulic cylinder

255: operating handle

256: pipe expanded and molded head portion

30: fixed unit

31: holder

32: screw hole column

33: lateral column

331: bearing block

332, 333: screw hole

34: check block

35: holding space

36: fixed handle

40: holding bracket

41: half-shaped die

42: semicircular groove

43: conical shallow groove

50: packing bolt

60, 60′: drive unit

61: hydraulic cylinder

611: screw stem

612: large diameter side-hole

613: holding hole

614: oil storage hole

615: small diameter hole

616: screw hole

62: piston rod

621: head portion

622: body portion

63, 63′: drive rod

631: plug-setting part

632, 632′: plug-receiving part

633: connecting part

634: retaining ring

635, 635′: jack

636, 636′: through hole

64: first elastic piece

65, 65′: lock bracket

651: screw stem

652, 652′: corner rod

653: screw hole

654: holding hole

655: through hole

66: first washer

67: second washer

68: oil

70: pipe expanded and molded piece

71: plug rod

72: retaining ring

73: extrusion head

74: circular groove

80: clip unit

81: first retaining ring

82: second elastic piece

83: ball bearing

84: third elastic piece

85: control ring

851: large diameter holding hole

852: clip hole

853: release hole

86: second retaining ring

90, 90′: operating unit

91: screw stem

92, 92′: operating handle

100: round pipe

101: molded endcap

102: flange

### DETAILED DESCRIPTION OF THE PREFERRED EMBODIMENTS

The above-mentioned and other technical contents, characteristics, and effects of the present invention referring to the reference drawings and the detailed descriptions of the preferred embodiments will be able to clearly present. Before the detailed descriptions of the present invention, it is noted that, the relative position description in the following texts of the specification is based on the orientation shown in each drawing, such as “the first direction X”, “the second direction Y”, and “the third direction Z”, which are perpendicular to each other. In addition, in the following descriptions of the specification, the similar element is assigned with the same number.

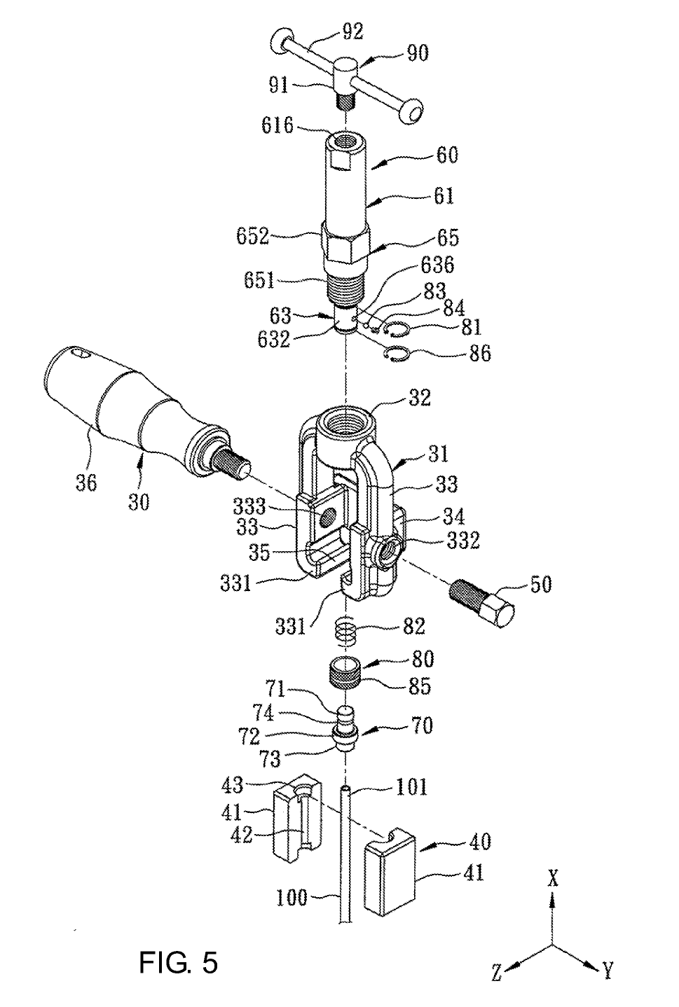

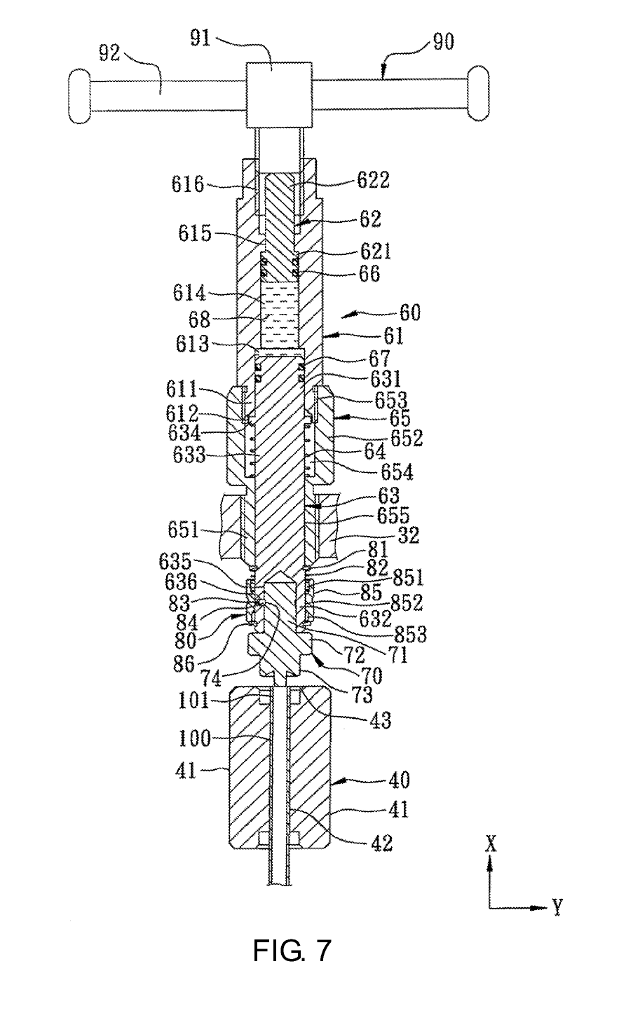

As shown in FIGS. 5, 6, and 7, the first preferred embodiment of the pipe body extrusion device of the present invention includes a fixed unit 30, a holding bracket 40, a packing bolt 50, a drive unit 60, a pipe expanded and molded piece 70, a clip unit 80, and an operating unit 90.

The fixed unit 30 includes a holder 31, and a fixed handle 36 fixed at the holder 31.

The holder 31 is equipped with a screw hole column 32 extending along the first direction X, two lateral columns 33 respectively extending from the screw hole column 32 along the first direction X, and a check block 34 fixed between the two lateral columns 33 along the second direction Y.

The open parts of the two lateral columns 33 relatively bend to form two spaced bearing blocks 331, in which one lateral column 33 includes a screw hole 332 through placed along the second direction Y.

The screw hole column 32, the lateral columns 33, the bearing blocks 331, and the check block 34 coordinate to form a holding space 35 for setting the holding bracket 40.

In the preferred embodiment, the fixed handle 36 is screwed and locked at the screw hole 333 of another lateral column 33 along the second direction Y to be positioned, but which is also screwed and locked at the check block 34 along the third direction Z to be positioned, or which is directly fixed at the check block 34 or another lateral column 33.

The holding bracket 40 includes two half-shaped dies 41 pairing with each other, in which each half-shaped die 41 is equipped with a semicircular groove 42 installed along the first direction X, and a conical shallow groove 43 with enlarged diameter installed at the junction of the head face of the half-shaped die 41 and the semicircular groove 42.

The packing bolt 50 is screwed and locked at the screw hole 332 to tightly push against the holding bracket 40 to be positioned.

The drive unit 60 includes a hydraulic cylinder 61, a piston rod 62 movably installed in one end of the hydraulic cylinder 61 along the first direction X, a drive rod 63 movably installed in another end of the hydraulic cylinder 61 along the first direction X, a first elastic piece 64 fitted at the drive rod 63, and a lock bracket 65 fitted at outside of the drive rod 63 and locked with the hydraulic cylinder 61.

The hydraulic cylinder 61 includes a screw stem 611 extending along the first direction X, and the following sequentially placed from the head face of the screw stem 611 along the first direction X, including a large diameter side-hole 612, a holding hole 613 with narrowed aperture from the large diameter side-hole 612, an oil storage hole 614 with narrowed aperture from the holding hole 613, a small diameter hole 615 with narrowed aperture from the oil storage hole 614, and a screw hole 616 with enlarged aperture from the small diameter hole 615 and connected with the head face of the hydraulic cylinder 61.

The piston rod 62 includes a head portion 621 plugged in the oil storage hole 614, and a body portion 622 extending from the head portion 621 and plugged in the small diameter hole 615 and the screw hole 616.

The drive unit 60 is further fitted at two first washers 66 of the head portion 621.

The drive rod 63 includes a plug-setting part 631 plugged in the holding hole 613, a plug-receiving part 632 placed at the opposite direction with the plug-setting part 631, a connecting part 633 installed between the plug-setting part 631 and the plug-receiving part 632, a retaining ring 634 formed between the plug-setting part 631 and the connecting part 633 and placed in the large diameter side-hole 612, a jack 635 installed along the first direction X and placed in the plug-receiving part 632, and a through hole 636 through the plug-receiving part 632 and the jack 635.

The drive unit 60 is further fitted at two second washers 67 of the plug-setting part 631.

The first elastic piece 64, which is a compressed spring in the preferred embodiment, is fitted at the connecting part 633 and stemmed by the retaining ring 634.

The lock bracket 65 includes a screw stem 651, a corner rod 652 enlarging diameter and extending from the screw stem 651 along the first direction X, and the following sequentially placed from the corner rod 652 along the first direction X, including a screw hole 653, a holding hole 654, and a through hole 655 with narrowed aperture from the holding hole 654 and through the screw stem 651.

When the lock bracket 65 is fitted at outside of the connecting part 633 of the drive rod 63 through the through hole 655, and the screw hole 653 locks with the screw stem 611 of the hydraulic cylinder 61, the first elastic piece 64 is placed in the holding hole 654 and stemmed by the retaining ring 634, and a constant partial pressure is provided to and makes the drive rod 63 move toward the piston rod 62.

The pipe expanded and molded piece 70 includes a plug rod 71 for plugging in the jack 635 of the drive rod 63, a retaining ring 72 enlarged diameter and molded from the plug rod 71, an extrusion head 73 extending from the retaining ring 72 along the first direction X, and a circular groove 74 installed at the plug rod 71.

The clip unit 80 includes a first retaining ring 81 fitted and fixed at the plug-receiving part 632 near the screw stem 651, a second elastic piece 82 fitted at the plug-receiving part 632 and stemmed by the first retaining ring 81, a ball bearing 83 and a third elastic piece 84 installed in the through hole 636 of the drive rod 63, a control ring 85 fitted at the plug-receiving part 632, and a second retaining ring 86 fitted and fixed at the plug-receiving part 632 to stem the control ring 83.

The control ring 85 includes the following sequentially installed along the first direction X, including a large diameter holding hole 851, a clip hole 852 with narrowed aperture from the holding hole 851, and a release hole 853 with enlarged aperture from the clip hole 852.

The first retaining ring 81 and the second retaining ring 86 are exemplified by C-type buckle for description in the preferred embodiment.

The second elastic piece 82 and the third elastic piece 84 are exemplified by compressed spring for description in the preferred embodiment.

When the second elastic piece 82 is limitedly placed between the first retaining ring 81 and the holding hole 851 of the control ring 85, a constant partial pressure is provided to and makes the control ring 85 reversely move toward the lock bracket 65, but the control ring 85 is stemmed by the second retaining ring 86 and cannot depart from the plug-receiving part 632, in the normal state, the clip hole 852 of the control ring 85 aligns with the through hole 636 of the drive rod 63, and the ball bearing 83 is elastically pushed by the third elastic piece 84 into the circular groove 74 of the pipe expanded and molded piece 70, and then the effect of the pipe expanded and molded piece 70 clipped to be positioned is produced; when the control ring 85 moves toward the direction of the lock bracket 65, so the release hole 853 aligns with the through hole 636, the third elastic piece 84 does not elastically push the ball bearing 83, and the ball bearing 83 withdraws from the circular groove 74, at this point, the pipe expanded and molded piece 70 is extracted, and the third elastic piece 84 is compressed, if the control ring 85 is released, the state of the clip hole 852 aligning with the through hole 636 will be recovered again, by way of this design, the pipe expanded and molded piece 70 is replaced conveniently and rapidly.

The operating unit 90 includes a screw stem 91 for screwing and locking at the screw hole 616 of the hydraulic cylinder 61, and an operating handle 92 installed at the screw stem 91.

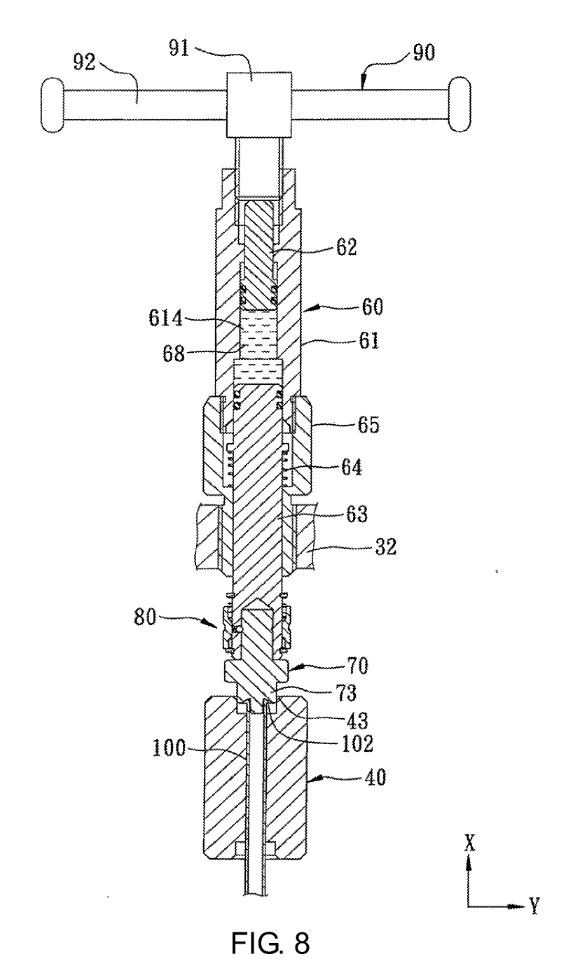

As shown in FIGS. 5, 6, 7, and 8, in using, a round pipe 100 is first put in the semicircular groove 42 of one of the half-shaped dies 41 of the holding bracket 40, then a molded endcap 101 of the round pipe 100 is placed in the conical shallow groove 43, then another half-shaped die 41 pairs with the above half-shaped die 41, then the holding bracket 40 is put in the holding space 35 of the holder 31 and touches the check block 34 and one of the lateral columns 33, and then the packing bolt 50 is turned to tightly push against the holding bracket 40, at this point, the holding bracket 40 is clipped to be positioned, and the molded endcap 101 of the round pipe 100 aligns with the screw hole column 32. After that, the screw stem 651 of the lock bracket 65 of the drive unit 60 is locked in the screw hole column 32 of the holder 31, until the extrusion head 73 of the pipe expanded and molded piece 70 touches the molded endcap 101, then the fixed handle 36 is held to tighten the operating handle 92 of the operating unit 90, thus the piston rod 62 is pushed by the screw stem 91 to move toward the drive rod 63, and the drive rod 63 is pushed by the oil 68 of the oil storage hole 614 for leading the pipe expanded and molded piece 70 to move toward molded endcap 101, through the configuration coordinated by the extrusion head 73 and the shallow groove 43, the molded endcap 101 is extruded, expanded, and molded to a flange 102. Afterwards, the operating handle 92 is released, then the drive rod 63 is automatically reset through the recovery elasticity of the first elastic piece 64, and the pipe expanded and molded piece 70 is led to depart from the holding bracket 40, and then the packing bolt 50 is released, and the holding bracket 40 is extracted from the holding space 35, finally, the round pipe 100 is extracted from the holding bracket 40.

Worthy of note is that, the head face of the flange 102 is convex arc-shaped or concave horn-shaped, which is achieved by different configuration coordinated by the extrusion head 73 and the shallow groove 43.

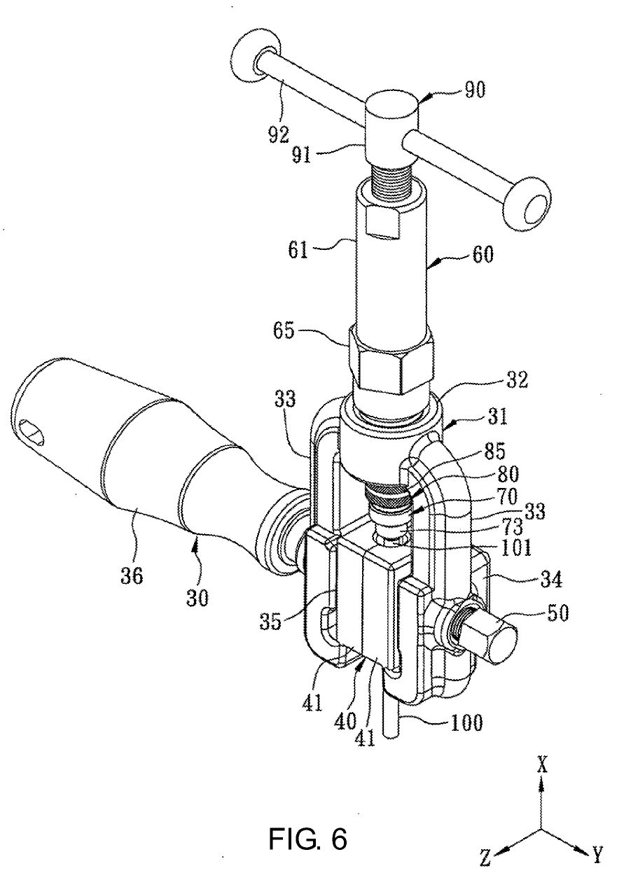

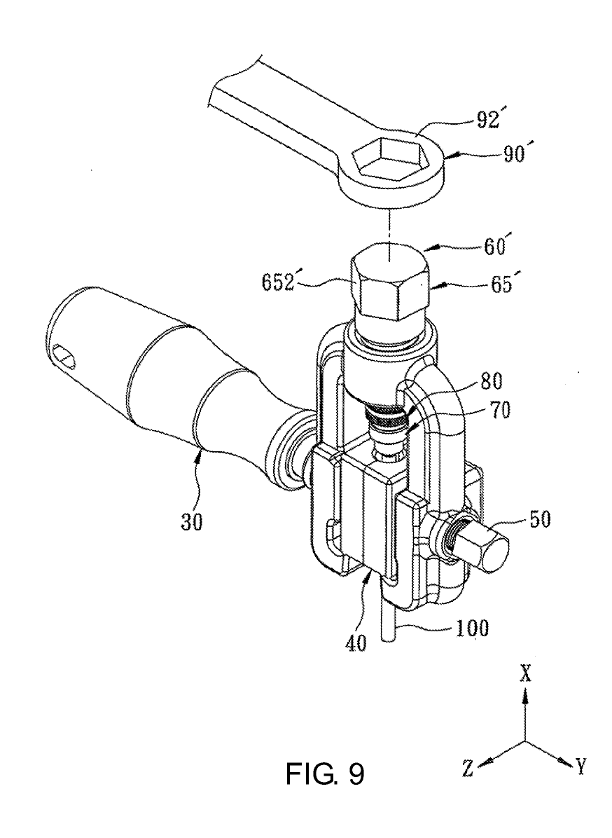

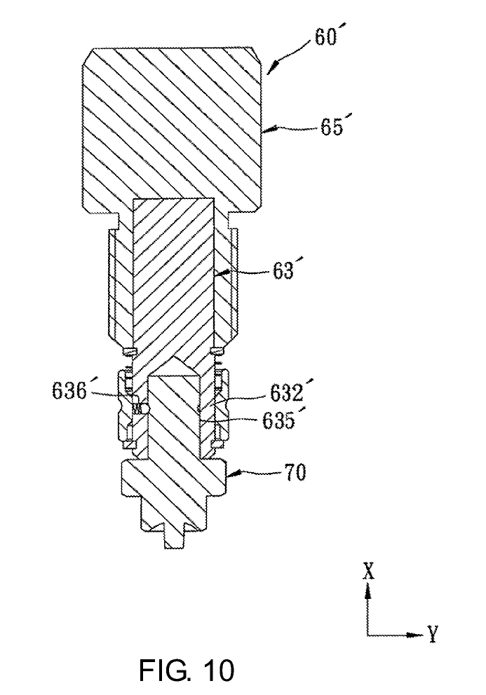

As shown in FIGS. 9, 10, 6, and 7, the second preferred embodiment of the pipe body extrusion device of the present invention includes a fixed unit 30, a holding bracket 40, a packing bolt 50, a drive unit 60′, a pipe expanded and molded piece 70, a clip unit 80, and an operating unit 90′.

The fixed unit 30, the holding bracket 40, the packing bolt 50, the pipe expanded and molded piece 70, and the clip unit 80 of the second preferred embodiment are same as those in the first preferred embodiment, and the descriptions are not repeated.

For the drive unit 60′, the hydraulic cylinder 61, the piston rod 62, and the first elastic piece 64 of the drive unit 60 are omitted, which only includes a lock bracket 65′, and a drive rod 63′ extending from the lock bracket 65′ along the first direction X, in which the lock bracket 65′ and the lock bracket 65 are identical, as for the drive rod 63′, which includes a plug-receiving part 632′ through the lock bracket 65′, and a jack 635′ and a through hole 636′ installed at the plug-receiving part 632′.

The operating unit 90′ includes a corner rod 652′ fitted at the lock bracket 65′, and an operating handle 92′ for the lock bracket 65′ leading the drive rod 63′ to move along the first direction X.

The difference between the first preferred embodiment and the second preferred embodiment is that the former achieves the effect of labor-saving operation through the design related to the hydraulic cylinder 61.

In addition, the operating handles 92-92′ can adopt handles facilitating rotation, which can reverse and transform operational angle. Summarized above, the pipe body extrusion device of the present invention can obtain the following effects and advantages, and exactly achieve the objects of the present invention:

1. Compared with the conventional pipe body extrusion device 20, the present invention has the effects and advantages of simple integral structure;

2. Compared with the conventional pipe body extrusion device 20, the present invention has the effects and advantages of easy and time-saving integral operation, and relatively enhancing the operational efficiency; and

3. For the present invention, the assembly or disassembly of the pipe expanded and molded piece 70 can be implemented by only pushing the control ring 83; compared with the assembly and disassembly operation made by the conventional pipe expanded and molded head portion 256 of the pipe body extrusion device 20, the present invention has the effects and advantages of easy operation and enhancing the operational efficiency.

The above descriptions is only for the preferred embodiments of the present invention, and cannot limit the scope of the present invention, and the simple equivalent changes and modifications made in the claims and summary of the present invention completely fall within the patent covering scope of the present invention.

1. A pipe body extrusion device, containing:
a fixed unit, including a holder, and a fixed handle installed at the holder, in which the holder is equipped with a screw hole column extending along the first direction, two lateral columns respectively extending from the screw hole column along the first direction, and a check block fixed between the two lateral columns along the second direction which is perpendicular to the first direction, the above screw hole column, lateral columns, and check block coordinated to form a holding space;
a holding bracket, for being put into the holding space, including two half-shaped dies pairing with each other, in which each half-shaped die is equipped with a semicircular groove installed along the first direction, and a shallow groove with enlarged diameter installed at the junction of the head face of the half-shaped die and the semicircular groove;
a packing bolt, locked into one of the lateral columns and pushing against the holding bracket along the second direction;
a drive unit, including a lock bracket screwed and locked at the screw hole column along the first direction, and a drive rod extending from the lock bracket along the first direction and aligning with the drive rod of the holding bracket, in which the drive rod is equipped with a plug-receiving part placed at outside of the lock bracket, a jack installed at the plug-receiving part along the first direction, and a through hole installed at the plug-receiving part and through the jack;
a pipe expanded and molded piece, including a plug rod plugged in the jack of the drive rod, an extrusion head extending toward the direction away from the plug rod and aligning with the shallow groove of the holding bracket, and a circular groove installed at the plug rod;
a clip unit, including a first retaining ring installed at the plug-receiving part near the lock bracket, a second elastic piece fitted at the plug-receiving part and stemmed by the first retaining ring, a ball bearing and a third elastic piece installed in the through hole of the drive rod, a control ring fitted at the plug-receiving part, and a second retaining ring installed at the plug-receiving part to stem a second retaining ring of the control ring; in which
the control ring includes a clip hole with small aperture and a release hole with large aperture, thus the ball bearing moves between the clip position and the release position, relative to the circular groove of the pipe expanded and molded piece; and
an operating unit is for driving the drive unit for leading the pipe expanded and molded piece to move along the first direction.

2. The pipe body extrusion device as claimed in claim 1, wherein the drive unit further includes a hydraulic cylinder, a piston rod, and a first elastic piece, and the operating unit includes a screw stem and an operating handle;
the hydraulic cylinder includes the following sequentially placed along the first direction, including a large diameter side-hole, a holding hole with narrowed aperture from the large diameter side-hole, an oil storage hole with narrowed aperture from the holding hole, a small diameter hole with narrowed aperture from the oil storage hole, and a screw hole with enlarged aperture from the small diameter hole;
the piston rod includes a head portion plugged in the oil storage hole, and a body portion extending from the head portion and plugged in the small diameter hole and the screw hole;
the drive rod further includes a plug-setting part plugged in the holding hole of the hydraulic cylinder, a plug-receiving part placed at the opposite direction with the plug-setting part, a connecting part installed between the plug-setting part and the plug-receiving part, a retaining ring formed between the plug-setting part and the connecting part and placed in the large diameter side-hole;
the lock bracket includes a screw stem screwed and locked at the screw hole column, a corner rod enlarging diameter and extending from the screw stem along the first direction, and the following sequentially placed from the corner rod along the first direction, including a screw hole, a holding hole, and a through hole with narrowed aperture from the holding hole and through the screw stem;
the first elastic piece is fitted at the connecting part;
if the lock bracket is fitted at outside of the drive rod, and through the screw hole of the lock bracket locking with the screw stem of the hydraulic cylinder, the first elastic piece is limitedly placed between the holding hole of the lock bracket and the retaining ring of the drive rod; and
the screw stem of the operating unit is screwed and locked at the screw hole of the hydraulic cylinder along the first direction, and the operating handle is installed at the screw stem, when the screw stem is rotated, the piston rod, the drive rod, and the pipe expanded and molded piece are driven to move along the first direction.

3. The pipe body extrusion device as claimed in claim 2, wherein the drive unit is further fitted at two first washers of the head portion of the piston rod, and at two second washers of the plug-setting part of the drive rod.
